(19) United States
(12) Patent Application Publication
(10) Pub. No.: US 2014/0352123 A1
(43) Pub. Date: Dec. 4, 2014

(54) PIPELINE PIG RETRIEVAL TOOL AND METHOD

(71) Applicant: Scott Sonnenberg, Drayton Valley (CA)

(72) Inventor: Scott Sonnenberg, Drayton Valley (CA)

(21) Appl. No.: 13/909,920

(22) Filed: Jun. 4, 2013

(51) Int. Cl. F16L 55/46

(52) U.S. Cl. CPC F16L 55/46
USPC 29/426.1

(57) ABSTRACT

A method of removing a pipeline pig from a pig trap barrel where the pig trap barrel has a danger region defined by a cone centered on an open end of the pig trap barrel, comprising operating a pig retrieval tool with a portion of the pig retrieval tool inside the pig trap barrel to retrieve the pig from the pig trap barrel while at least a handle part of the pig retrieval tool is outside the danger region. A pig retrieval tool. A combination of a pipeline pig, a pig trap barrel retaining the pipeline pig, and a pig retrieval tool having a shaft with a hook, a bridge laterally extended from the shaft, and a handle part connected to the shaft through the bridge.

### TECHNICAL FIELD

This document relates to a pipeline pig retrieval tool and method.

### BACKGROUND

Pipeline pigs are versatile devices that scrape the inside of a pipe to clean the pipe. A variety of techniques may be used to extract a pig from the open end of a depressurized pig trap barrel. One method involves a user positioned at least partially in front of the barrel and hooking the pig with hook at the end of a straight rod. An exemplary rod is shown in U.S. Pat. No. 4,759,579. Such a method has resulted in fatalities and injuries when pressure from hydrates or other deposits carried with the pig into the barrel is suddenly released during extraction to propel the pig into the user. Other extraction techniques use winch systems to remove the pig.

### SUMMARY

A method of removing a pipeline pig from a pig trap barrel where the pig trap barrel has a danger region defined by a cone centered on an open end of the pig trap barrel, comprising operating a pig retrieval tool with a portion of the pig retrieval tool inside the pig trap barrel to retrieve the pig from the pig trap barrel while at least a handle part of the pig retrieval tool is outside the danger region.

A pig retrieval tool is also disclosed. A combination is also disclosed of a pipeline pig, a pig trap barrel retaining the pipeline pig, and a pig retrieval tool having a shaft with a hook, a bridge laterally extended from the shaft, and a handle part connected. to the shaft through the bridge.

Various embodiments, there may be included any one or more of the following features: The portion of the pig retrieval tool includes a shaft with a hook. The handle part is connected to the shaft through a bridge that extends laterally from the shaft. The handle part, bridge, and shaft collectively form a U-shape. Operating is carried out while a wall portion of the pig trap barrel is between the pipeline pig and at least a portion of the handle. The handle part, bridge, and shaft collectively form an S-shape. The handle part and portion are formed from a bent rod. One or more stiffeners are between the shaft and handle part. The handle part is parallel to the portion. The portion is positioned between the handle part and the pipeline pig.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is side elevation section view illustrating a method and apparatus for removing a pipeline pig from a pig trap barrel.

### DETAILED DESCRIPTION

Immaterial modifications may be made to the embodiments described here without departing from what is covered by the claims.

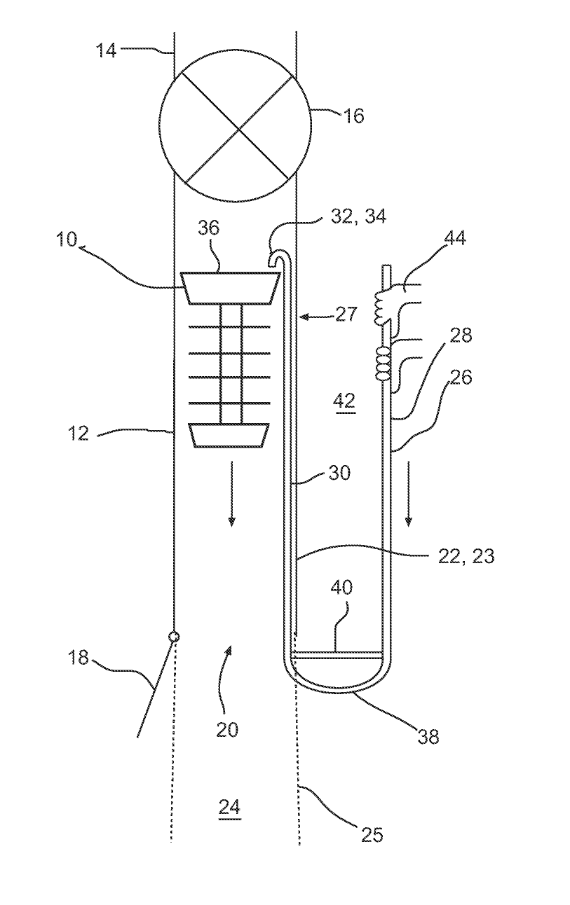

List of reference elements appearing in FIG. 1:
10—pig
12—pig trap barrel
14—pipeline
16—valve
18—gate
20—end
22—one or more sidewalls
23—wall portion
24—danger region
25—cone
26—pig retrieval tool
27—portion
28—handle part
30—shaft
32—hook
34—end
36—rear flange
38—bridge
40—one or more stiffeners
42—well
44—user

A pipeline pig is a device that is pushed with fluid pressure through pipe lines or conduits as an aid for removing deposits that form on the inside surfaces of the pipe or conduit. Pipeline pigs are inserted into and removed from a fluid circuit using a pig launcher and trap, respectively. A pig trap includes a sealed barrel that receives the pig. Once the pig is received, the barrel is depressurized.

Pigs may also be employed as markers. For example a pig may be inserted, between separate charges of different fluids to indicate the end of a specific charge and the beginning of another charge. Pigs can further be used to inspect the pipe or conduit. Pigs can also be used to seal off a portion of a pipe to permit work to be carried out on the pipe.

Pigs often take the form of spheriods or plugs or torpedo type configurations that have diameters slightly smaller than the inner diameter of the pipes or conduits, Pigs may be constructed of a variety of materials such as resilient foam, rubber, or metals such as stainless steel or aluminum. Pigs may have lateral extensions like brushes, mesh, arms, screws, and other suitable components to assist in pipe scraping.

Referring to FIG. 1, a pipeline pig 0 is positioned in a pig trap barrel 12 that is connected to a pipeline 14. A valve 16 may be used to catch the pig 10 in the barrel 12. The pig trap barrel 12 may have a variety of suitable shapes, and the one shown has a cylindrical cross section terminating in a gate 18 at an end 20 of barrel 12. A trapped pig 10 may thus be manually pulled out of barrel 12 through open end 20 as shown. Rails or other devices (not shown) may be present in, outside, or in and outside barrel 12 to facilitate pig 10 removal. Barrel 12 has one or more sidewalls 22 that form the barrel 12.

When in the open position shown in FIG. 1, pig trap barrel 12 has a danger region 24 defined by a cone 25 (partially shown in dotted lines) centered on open end 20 of the pig trap barrel 12. The danger region 24 reflects the fact that in rare circumstances sudden pressure build up and release behind pig 10 may launch pig 10 out of open end 20 despite the fact that barrel 12 is depressurized before pig extraction is attempted. Such pressure build up may be caused by a sudden release of pressure from various deposits or material, such as hydrates, that are unintentionally delivered into barrel 12 with pig 10. In effect, danger region 24 defines a line of fire of barrel 12, with pig 10 acting as a missile. Cone 25 is shown as expanding with increasing distance from the open end 20, and may be a cylinder in some cases.

Referring to FIG. 1, a method of removing a pipeline pig 10 from barrel 12 while a user 44 is outside of the danger region 24 is illustrated. The method comprises operating a pig retrieval tool 26 to retrieve the pig 10 from the barrel 12. During operation, a portion 27 of the pig retrieval tool 26 is inside the pig trap barrel 12 while at least a. handle part 28 of the pig retrieval tool 26 is outside the danger region 24.

Portion 27 may include a shaft 30 with a hook 32, for example at an end 34 of the shaft 30. Hook 32 may be sized to have a lateral profile narrow enough to fit between sidewall 22 and pig 10 during insertion. Once inserted at least partially past pig 10, hook 32 may be able to latch onto a part of pig 10, for example a rear flange 36 of pig 10. Other suitable techniques other than a hook 32 may be used to permit shaft 30 to catch pig 10, for example a magnetic device, a rope or cable loop, a suction device, or a female or male connector with a corresponding male or female connector on pig 10.

The handle part 28 may be connected to the shaft 30 through a bridge 38 that extends laterally from the shaft 30. One or more stiffeners 40 may be between the shaft 30 and handle part 28, for example to stabilize the bridge 38 or as part of the bridge 38. Stiffener 40 may double as a second handle part. Handle 28 may be provided in a. length that is as long or longer than a length of shaft 30 to further distance handle 28 from being in the line of fire.

The handle part 28, bridge 38, and shaft 30 may collectively form a shape, for example if the handle part 28, bridge 38, and shaft 30 collectively form an S-shape as shown. Such shapes may be possible for example by providing the handle part 28 and portion 27 from a bent rod as shown. In some embodiments, the handle part 28 is parallel to the portion 27, for example as shown. Such shapes and configurations allow operation to be carried out while a wall portion 23 of the pig trap barrel 12 is between the pipeline pig 10 and at least a portion of the handle 28. Thus, the handle 28 and shaft 30 may define a well 42 containing the portion 23 of wall 22 during operation. Such configurations permit a user 44 to operate tool 26 whilst alongside barrel 12 instead of in the line of fire defined by danger region 24. The U and S shapes may be defined when projected in a plane, and neither shape requires curved portions or integral connections between parts.

In some cases providing handle part 28 as a shaft (as shown) parallel with shaft 30 permits handle part 28 to axially slide through the hands of user 44 without hooking the user 44 if pig 10 is accidentally launched from barrel 12 out open end 20. In other cases, handle part 28 may be non parallel to shaft 30, for example if handle part 28 forms a right or other non zero angle with shaft 30 and extends laterally relative to shaft 30. Other suitable configurations may be used. When parallel or relatively angled, handle 28 is positioned off axis from shaft 30 as shown.

In some cases the portion 27 of tool 26 is positioned between the handle part 28 and the pipeline pig 10 as shown during operation. In other cases (not shown), PIG 10 may be between portion 27 and tool 26.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A method of removing a pipeline pig from a pig trap barrel where the pig trap barrel has a danger region defined by a cone centered on an open end of the pig trap barrel, comprising operating a pig retrieval tool with a portion of the pig retrieval tool inside the pig trap barrel to retrieve the pig from the pig trap barrel while at least a handle part of the pig retrieval tool is outside the danger region.

2. The method of claim 1 in which the portion of the pig retrieval tool includes a shaft with a hook.

3. The method of claim 2 in which the handle part is connected to the shaft through a bridge that extends laterally from the shaft

4. The method of claim 3 in which the handle part, bridge, and shaft collectively form a U-shape.

5. The method of claim 4 in which operating is carried out while a wall portion of the pig trap barrel is between the pipeline pig and at least a portion of the handle.

6. The method of claim 4 in which the handle part, bridge, and shaft collectively form an S-shape.

7. The method of claim 4 in which the handle part and portion are formed from a bent rod.

8. The method of claim 4 further comprising one or more stiffeners between the shaft and handle part.

9. The method of claim 1 in which the handle part is parallel to the portion.

10. The method of claim 1 in which the portion is positioned between the handle part and the pipeline pig.
